(19) United States
(12) Patent Application Publication
(10) Pub. No.: US 2026/0037062 A1
(43) Pub. Date: Feb. 5, 2026

(54) GAZE ESTIMATION SYSTEM AND GAZE ESTIMATION METHOD

(71) Applicant: LITE-ON TECHNOLOGY CORPORATION, TAIPEI CITY (TW)

(72) Inventors: Yan-Ting LIU, Taipei City (TW); Hao-Min CHANG, Taipei City (TW)

(21) Appl. No.: 19/237,261

(22) Filed: Jun. 13, 2025

Related U.S. Application Data
(60) Provisional application No. 63/678,144, filed on Aug. 1, 2024.

(51) Int. Cl. G06F 3/01; G02B 27/00; G06V 40/18

(52) U.S. Cl. CPC G06F 3/013; G02B 27/0093; G06V 40/193; G06V 40/197

(57) ABSTRACT

Provided is a gaze estimation method that includes deriving a resized face image and a resized eye image from an image of a subject captured by a camera device, extracting a first feature representation from the resized face image using a first feature extraction model, extracting a second feature representation from the resized eye image using a second feature extraction model, combining the first feature representation and the second feature representation to generate a combined feature representation, and determining a gaze direction of the subject based on the combined feature representation using a regression model.

### CROSS REFERENCE TO RELATED APPLICATIONS

This application claims the benefit of U.S. Provisional Application No. 63/678,144 filed Aug. 1, 2024, the entirety of which is incorporated by reference herein.

### BACKGROUND OF THE INVENTION

### Field of the Invention

The present disclosure relates to image processing and image analysis techniques, and, in particular, to a gaze estimation system and a gaze estimation method.

### Description of the Related Art

In recent years, gaze estimation technologies have attracted increasing attention due to their potential applications in various fields. For example, in automotive systems, a gaze estimation system can be used to monitor a driver's attention and detect signs of distraction, thereby enhancing driving safety. In digital signage systems, gaze estimation can assist in determining which areas of a display attract more attention from passing individuals, providing valuable data for advertising strategies. In retail environments such as convenience stores and supermarkets, surveillance systems equipped with gaze estimation capabilities can identify the products that draw the most consumer interest.

Conventional gaze estimation systems typically rely on analyzing a facial image captured by a camera to infer the subject's gaze direction. However, facial images inherently contain many features that are unrelated to gaze direction, such as individual appearance differences, illumination variations, and background noise. These irrelevant features may interfere with the learning process of gaze estimation models and degrade the estimation accuracy.

Furthermore, many existing methods extract gaze-related features using a single input source without separately focusing on critical regions, such as the eye region. This approach can limit the model's ability to concentrate on the most gaze-relevant information, especially under real-world conditions where variations in lighting, head pose, and occlusions (e.g., sunglasses, eyeglasses) are common.

Therefore, there is a need for a gaze estimation system and a gaze estimation method that can improve the robustness and precision of gaze estimation.

### BRIEF SUMMARY OF THE INVENTION

An embodiment of the present disclosure provides a gaze estimation system. The gaze estimation system includes a camera device and a processing circuitry. The camera device is configured to capture an image of a subject. The processing circuitry is coupled to the camera device, and further includes an image processing unit and a gaze inference unit. The image processing unit is configured to derive a resized face image and a resized eye image from the image of the subject. The image processing unit is configured to extract a first feature representation from the resized face image using a first feature extraction model, extract a second feature representation from the resized eye image using a second feature extraction model, combine the first feature representation and the second feature representation to generate a combined feature representation, and determine a gaze direction of the subject based on the combined feature representation using a regression model.

In an embodiment, the gaze estimation system further includes a model training unit. The model training unit is configured to train the first feature extraction model, the second feature extraction model, and the regression model jointly using a training dataset containing multiple pairs of a training face image and a training eye image, and corresponding gaze labels.

In an embodiment, the model training unit is further configured to optimize the first feature extraction model using a training loss comprising a gaze estimation loss and an adversarial loss. The gaze estimation loss is minimized to preserve gaze-relevant features, and the adversarial loss is minimized to suppress gaze-irrelevant features. The gaze-irrelevant features include luminance features and individual appearance features.

In an embodiment, the model training unit is further configured to generate a reconstructed face image from the first feature representation using a reconstruction model, and compute the adversarial loss based on a reconstruction loss between the reconstructed face image and the training face image.

In an embodiment, the model training unit is further configured to identify a face bounding box and an eye bounding box from a training image, apply data augmentation to the training image, and derive one of the multiple pairs of the training face image and the training eye image in the training dataset from the face bounding box and the eye bounding box. The data augmentation includes applying a scaling transformation to the face bounding box and the eye bounding box, applying a translation transformation to the face bounding box and the eye bounding box, and/or adjusting a luminance level of the training image.

In an embodiment, the data augmentation further includes generating a mask based on eye landmarks, and applying the mask to the training image to selectively preserve a gaze-relevant region in the training eye image.

In an embodiment, the model training unit is further configured to train the second feature extraction model using an auxiliary task configured to predict one or more pre-defined eye features from the training eye image. The auxiliary task is designed to encourage the second feature extraction model to preserve information relevant to the pre-defined eye features in the second feature representation. The pre-defined eye features includes eyelids, eye corners, iris boundaries, limbus boundaries, a pupil center, and/or an eyeball center.

In an embodiment, the model training unit is further configured to train the first feature extraction model using an auxiliary task configured to predict one or more pre-defined facial features from the training face image. The auxiliary task is designed to encourage the first feature extraction model to preserve information relevant to the pre-defined facial features in the first feature representation. The pre-defined facial features includes facial geometry information and/or head pose information.

In an embodiment, the model training unit is further configured to train the regression model using a training process that includes applying a classification loss for coarse gaze direction estimation and a regression loss for fine-grained gaze direction estimation. The weight of the classification loss decreases and the weight of the regression loss increases with training epoch.

In an embodiment, the gaze inference unit is further configured to determine the gaze direction of the subject by applying a classification model to the combined feature representation to generate a coarse gaze class, and applying a regression model to determine the gaze direction based on the combined feature representation and the coarse gaze class. The model training unit is further configured to train the classification model using a classification loss and the regression model using a regression loss.

In an embodiment, the image processing unit is further configured to derive the resized face image and the resized eye image by identifying a face bounding box and an eye bounding box from the image of the subject using an object detection model or a landmark detection model, cropping a face image and an eye image from the image of the subject based on the face bounding box and the eye bounding box, respectively, and downscaling the cropped face image and the cropped eye image to generate the resized face image and the resized eye image, respectively.

In an embodiment, the image processing unit is further configured to downscale the cropped face image and the cropped eye image, such that the resized eye image preserves more pixel-level detail corresponding to an eye of the subject than a corresponding eye region within the resized face image.

In an embodiment, in response to detecting multiple face regions in the image of the subject, the image processing unit is further configured to select the face bounding box based on proximity to a predefined reference position within the image.

In an embodiment, the image processing unit is further configured to identify a left eye bounding box and a right eye bounding box from the image of the subject and to select, from the left eye bounding box and the right eye bounding box, the one that is closer to the camera device as the eye bounding box for cropping the eye image.

In an embodiment, the image processing unit is further configured to maintain the selected eye bounding box across multiple frames and to switch to the other eye bounding box for cropping the eye image only when a predefined condition indicating a sufficient change is satisfied.

In an embodiment, the camera device is a near-infrared camera configured to capture the image of the subject as a grayscale image, and the first feature extraction model, the second feature extraction model, and the regression model are trained using grayscale training images converted from color images via a model trained to simulate near-infrared image characteristics.

In an embodiment, the processing circuitry is further configured to perform at least one of the following actions based on the determined gaze direction: (i) modifying a display output of a display device, (ii) flashing an indicator light, (iii) generating an audio alert through an audio output device, (iv) activating an autopilot unit to take over vehicle control, and (v) activating a haptic output device to generate a vibration alert.

An embodiment of the present disclosure provides a gaze estimation method. The gaze estimation method is executed by one or more processors. The gaze estimation method includes deriving a resized face image and a resized eye image from an image of a subject captured by a camera device, extracting a first feature representation from the resized face image using a first feature extraction model, extracting a second feature representation from the resized eye image using a second feature extraction model, combining the first feature representation and the second feature representation to generate a combined feature representation, and determining a gaze direction of the subject based on the combined feature representation using a regression model.

In an embodiment, the gaze estimation method further includes training the first feature extraction model, the second feature extraction model, and the regression model jointly using a training dataset comprising multiple pairs of a training face image and a training eye image, and corresponding gaze labels.

In an embodiment, the gaze estimation method further includes optimizing the first feature extraction model using a training loss comprising a gaze estimation loss and an adversarial loss. The gaze estimation loss is minimized to preserve gaze-relevant features, and the adversarial loss is minimized to suppress gaze-irrelevant features. The gaze-irrelevant features include luminance features and individual appearance features.

In an embodiment, the gaze estimation method further includes generating a reconstructed face image from the first feature representation using a reconstruction model, and computing the adversarial loss based on a reconstruction loss between the reconstructed face image and the training face image.

In an embodiment, the gaze estimation method further includes identifying a face bounding box and an eye bounding box from a training image, applying data augmentation to the training image, and deriving one of the multiple pairs of the training face image and the training eye image in the training dataset from the face bounding box and the eye bounding box. The data augmentation includes applying a scaling transformation to the face bounding box and the eye bounding box, applying a translation transformation to the face bounding box and the eye bounding box, and/or adjusting a luminance level of the training image.

In an embodiment, the gaze estimation method further includes training the second feature extraction model using an auxiliary task configured to predict one or more pre-defined eye features from the training eye image. The auxiliary task is designed to encourage the second feature extraction model to preserve information relevant to the pre-defined eye features in the second feature representation. The pre-defined eye features includes eyelids, eye corners, iris boundaries, limbus boundaries, a pupil center, and/or an eyeball center.

In an embodiment, the gaze estimation method further includes training the first feature extraction model using an auxiliary task configured to predict one or more pre-defined facial features from the training face image. The auxiliary task is designed to encourage the first feature extraction model to preserve information relevant to the pre-defined facial features in the first feature representation. The pre-defined facial features includes facial geometry information and/or head pose information.

In an embodiment, the gaze estimation method further includes training the regression model using a training process that includes applying a classification loss for coarse gaze direction estimation and a regression loss for fine-grained gaze direction estimation. The weight of the classification loss decreases and the weight of the regression loss increases with training epoch.

In an embodiment, the gaze estimation method further includes determining the gaze direction of the subject by applying a classification model to the combined feature representation to generate a coarse gaze class, and applying a regression model to determine the gaze direction based on the combined feature representation and the coarse gaze class. The classification model is trained using a classification loss, and the regression model using a regression loss.

In an embodiment, the operation of deriving the resized face image and the resized eye image further includes identifying a face bounding box and an eye bounding box from the image of the subject using an object detection model or a landmark detection model, cropping a face image and an eye image from the image of the subject based on the face bounding box and the eye bounding box, respectively, and downscaling the cropped face image and the cropped eye image to generate the resized face image and the resized eye image, respectively.

In an embodiment, the cropped face image and the cropped eye image are downscaled, such that the resized eye image preserves more pixel-level detail corresponding to an eye of the subject than a corresponding eye region within the resized face image.

In an embodiment, the gaze estimation method further includes in response to detecting multiple face regions in the image of the subject, selecting the face bounding box based on proximity to a predefined reference position within the image.

In an embodiment, the gaze estimation method further includes identifying a left eye bounding box and a right eye bounding box from the image of the subject, and selecting, from the left eye bounding box and the right eye bounding box, the one that is closer to the camera device as the eye bounding box for cropping the eye image.

In an embodiment, the gaze estimation method further includes maintaining the selected eye bounding box across multiple frames, and switching to the other eye bounding box for cropping the eye image only when a predefined condition indicating a sufficient change is satisfied.

In an embodiment, the camera device is a near-infrared camera configured to capture the image of the subject as a grayscale image. The first feature extraction model, the second feature extraction model, and the regression model are trained using grayscale training images converted from color images via a model trained to simulate near-infrared image characteristics.

In an embodiment, the gaze estimation method further includes performing at least one of the following actions based on the determined gaze direction: (i) modifying a display output of a display device, (ii) flashing an indicator light, (iii) generating an audio alert through an audio output device, (iv) activating an autopilot unit to take over vehicle control, and (v) activating a haptic output device to generate a vibration alert.

According to the embodiments of the present disclosure, the gaze estimation system and method described herein effectively address various limitations encountered in prior techniques. In particular, by separately extracting features from both a face image and an eye image and combining them for gaze estimation, the system is able to simultaneously capture broader facial context and fine-grained ocular details, resulting in improved gaze estimation accuracy. Furthermore, the introduction of an adversarial training mechanism for the face feature extraction model suppresses gaze-irrelevant features, such as variations in luminance and individual appearance, which previously degraded estimation robustness.

Additionally, by using auxiliary tasks to encourage the preservation of gaze-relevant facial and eye features during feature extraction, the system enhances the semantic richness of intermediate feature representations, thereby facilitating more precise inference. The use of dynamic loss weighting strategies during regression model training further mitigates bias and variance issues that typically arise in gaze estimation tasks.

Through careful pre-processing of input images, including intelligent selection of face and eye bounding boxes and targeted resizing strategies, the system ensures that essential visual information is preserved even under hardware and computational constraints. Moreover, by integrating mechanisms such as hysteresis control for eye selection, and by enabling responsive actions based on the estimated gaze direction, the system achieves practical reliability and responsiveness suitable for real-world applications, such as driver monitoring, digital signage interaction, and customer behavior analysis.

### BRIEF DESCRIPTION OF THE DRAWINGS

The present disclosure can be more fully understood by reading the subsequent detailed description and examples with references made to the accompanying drawings, wherein:

FIG. 1 illustrates a system architecture diagram of a gaze estimation system, according to an embodiment of the present disclosure;

FIG. 2 illustrates a flow diagram of a gaze estimation method, according to an embodiment of the present disclosure;

FIG. 3 illustrates a training process for training the first feature extraction model, according to an embodiment of the present disclosure;

FIG. 4 illustrates a training process that uses an auxiliary task for training the second feature extraction model, according to an embodiment of the present disclosure;

FIG. 5 illustrates a training process for training the regression model, according to an embodiment of the present disclosure;

FIG. 6 illustrates a training process for training the classification model and the regression model, according to an embodiment of the present disclosure;

FIG. 7 illustrates a process for constructing the training dataset, according to an embodiment of the present disclosure; and

FIG. 8 illustrates a pre-processing process executed by the image processing unit, prior to the feature extraction operations, according to an embodiment of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

In each of the following embodiments, the same reference numbers represent identical or similar elements or components.

Ordinal terms used in the claims, such as “first,” “second,” “third,” etc., are only for convenience of explanation, and do not imply any precedence relation between one another.

The descriptions provided below for embodiments of devices or systems are also applicable to embodiments of methods, and vice versa.

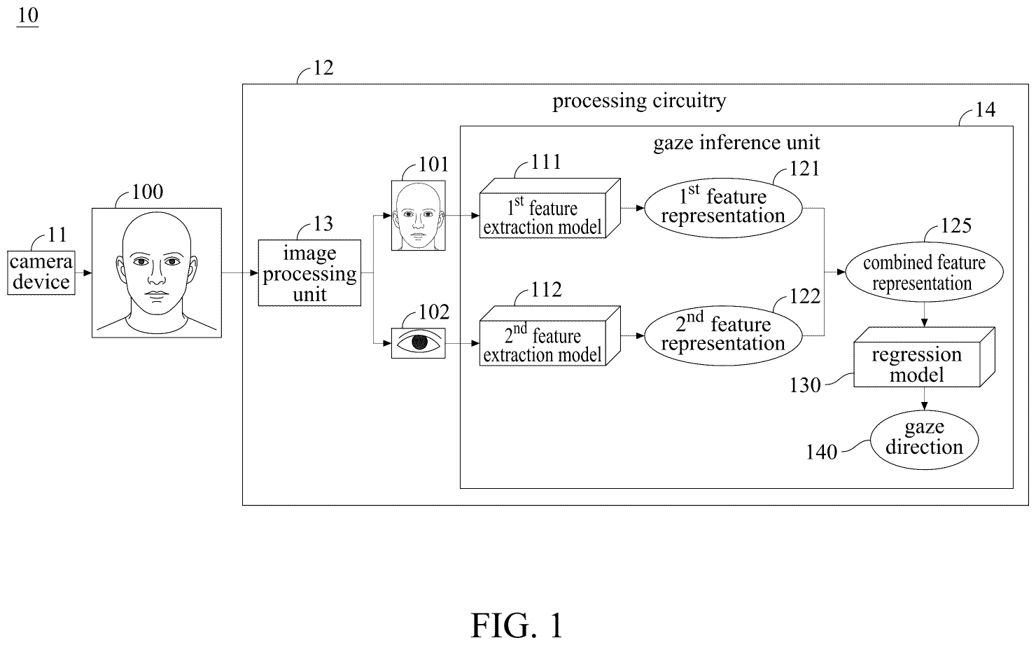

FIG. 1 illustrates a system architecture diagram of a gaze estimation system 10, according to an embodiment of the present disclosure. As shown in FIG. 1, the gaze estimation system 10 includes a camera device 11 and a processing circuitry 12. The processing circuitry 12 further includes an image processing unit 13 and a gaze inference unit 14.

The camera device 11 is configured to capture an image of a subject. In different application scenarios, the subject may be a driver inside a vehicle, a passerby in front of a digital signage display, or a customer in a retail environment. The captured image may be, for example, a color image or a grayscale image, depending on the type of the camera device 11 used. In some embodiments, the camera device 11 may be a near-infrared (NIR) camera configured to capture grayscale images with enhanced low-light performance.

The processing circuitry 12 is configured to perform various processing operations on the image captured by the camera device 11, including image processing and gaze estimation. The processing circuitry 12 may be implemented using one or more processors, one or more application-specific integrated circuits (ASICs), one or more field-programmable gate arrays (FPGAs), one or more programmable logic devices (PLDs), or other combinations of hardware, firmware, and/or software components. The processing circuitry 12 is configured to execute functions of the image processing unit 13 and the gaze inference unit 14, either by dedicated hardware circuits or by general-purpose processors executing software instructions.

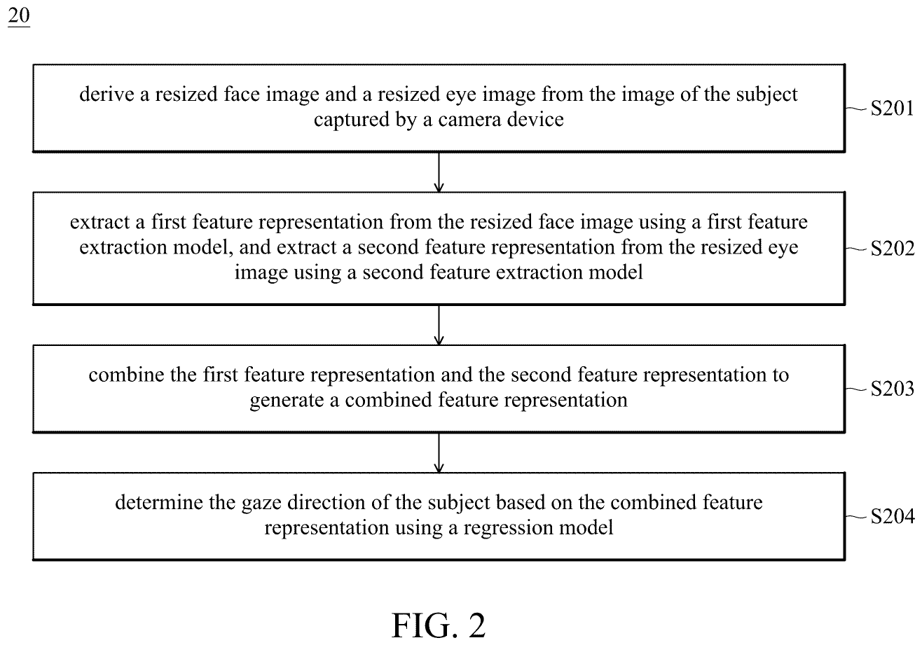

The detailed operations performed by the image processing unit 13 and the gaze inference unit 14 will be elaborated hereinafter with reference to FIG. 2.

FIG. 2 illustrates a flow diagram of a gaze estimation method 20, according to an embodiment of the present disclosure. As shown in FIG. 2, the gaze estimation method 20 includes steps S201 to S204. It should be noted that the components involved in FIG. 2 are illustrated in FIG. 1. Therefore, FIG. 1 and FIG. 2 may be jointly referenced to better understand the operations and structure of the present embodiment.

In step S201, the image processing unit 13 derives a resized face image 101 and a resized eye image 102 from the image 100 of the subject captured by the camera device 11. Specifically, the image processing unit 13 may identify a face region and an eye region within the captured image 100, crop the identified regions, and perform resizing operations to standardize the face image 101 and the eye image 102 to predetermined dimensions suitable for subsequent feature extraction. The resizing process can facilitate uniformity of input data and enhance the performance of machine learning models downstream.

In step S202, the gaze inference unit 14 extracts a first feature representation 121 from the resized face image 101 using a first feature extraction model 111, and extracts a second feature representation 122 from the resized eye image 102 using a second feature extraction model 112. The first feature extraction model 111 and the second feature extraction model 112 may be implemented by different neural network architectures for processing facial and ocular characteristics, respectively. The extracted feature representations may be embodied as feature maps, vectors, or tensors, and contain abstracted information capturing salient aspects of the face and the eye necessary for accurate gaze estimation.

In step S203, the gaze inference unit 14 combines the first feature representation 121 and the second feature representation 122 to generate a combined feature representation 125. In some implementations, the combination may be achieved by concatenating the first feature representation 121 and the second feature representation 122 along a specified dimension. Alternatively, other combination techniques such as summation, averaging, or feature fusion using learnable layers may also be used. The combined feature representation 125 is expected to integrate complementary information from both the face and the eye regions to enhance the robustness of gaze estimation.

In step S204, the gaze inference unit 14 determines the gaze direction 140 of the subject based on the combined feature representation 125 using a regression model 130. In particular, the combined feature representation 125 serves as the input to the regression model 130, and the regression model 130 outputs a predicted or inferred gaze direction 140 of the subject. The regression model 130 may be implemented using a fully connected neural network, a multilayer perceptron (MLP), a support vector regression (SVR) model, or other suitable regression techniques capable of mapping the combined feature space to continuous gaze direction outputs, but the present disclosure is not limited thereto.

Depending on specific application scenarios, the gaze direction 140 may be represented in various forms. For instance, the gaze direction 140 may be expressed as a pair of gaze angles relative to a coordinate system, including a yaw angle indicating horizontal rotation and a pitch angle indicating vertical rotation. In automotive applications, only the yaw and pitch angles are typically necessary because the roll angle has minimal influence on monitoring the driver's attention. Alternatively, the gaze direction 140 may be represented as a three-dimensional unit vector for applications requiring more precise spatial orientation. In certain simplified scenarios, the gaze direction 140 may be characterized by a single angular value, such as only the yaw angle, to represent horizontal gaze deviation from a reference axis, thereby reducing computational complexity.

In an embodiment, the gaze estimation system 10 may further include a model training unit, though not illustrated in FIG. 1. The model training unit may be configured to train the first feature extraction model 111, the second feature extraction model 112, and the regression model 130 jointly using a training dataset containing multiple pairs of a training face image and a training eye image, and corresponding gaze labels. The model training unit may be implemented in various ways, including as part of the processing circuitry 12, or implemented by a remote server computer configured to perform model training operations and subsequently deploy the trained models to the processing circuitry 12 for inference. The training face images and training eye images serve to provide the visual inputs representing different facial and ocular states under various conditions, while the gaze labels serve as the supervised ground-truth references indicating the true gaze directions associated with each image pair, thereby guiding the training of the respective models.

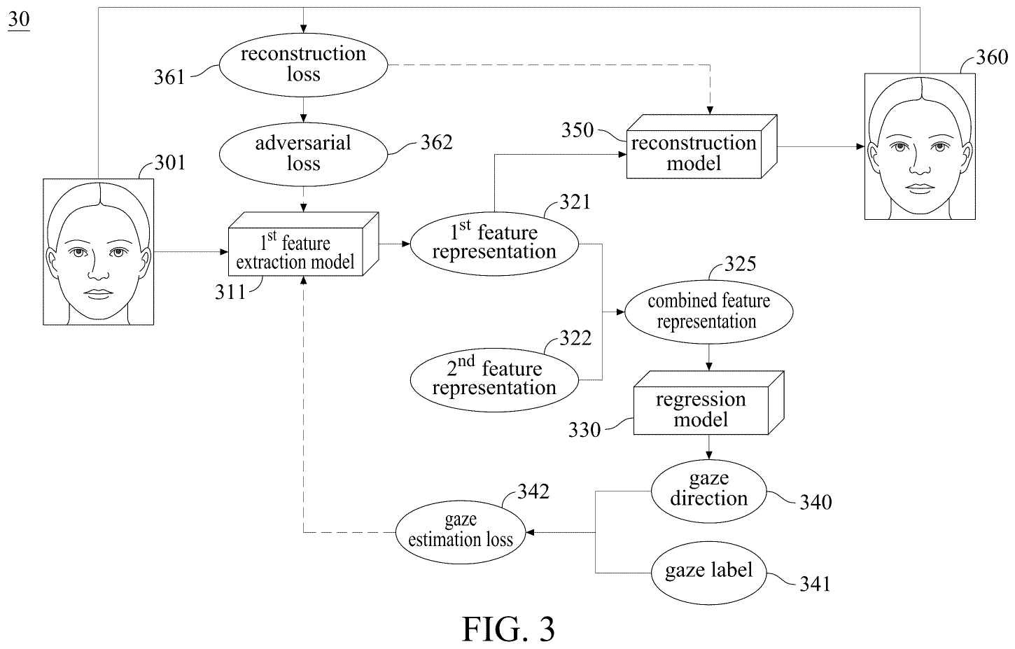

In an embodiment, the model training unit is further configured to optimize the first feature extraction model 111 using a training loss comprising a gaze estimation loss and an adversarial loss. The gaze estimation loss is minimized to encourage the first feature extraction model 111 to preserve gaze-relevant features necessary for accurate gaze direction estimation. Conversely, the adversarial loss is minimized to suppress gaze-irrelevant features, including but not limited to luminance features resulting from lighting variations and individual appearance features such as facial identity traits. The combination of the gaze estimation loss and the adversarial loss enables the first feature extraction model 111 to extract features that are robust against environmental changes and subject-specific differences, thereby improving the generalizability and accuracy of gaze estimation. Further details regarding the training process of the first feature extraction model are illustrated in FIG. 3 and will be described below.

FIG. 3 illustrates a training process 30 for training the first feature extraction model 311, according to an embodiment of the present disclosure. It should be understood that FIG. 1 depicts the inference phase of the gaze estimation system 10, while FIG. 3 depicts the training phase, and thus the same or similar components are denoted with different reference numerals for clarity.

As shown in FIG. 3, a training face image 301 of a subject is input to the first feature extraction model 311 to generate a first feature representation 321. The first feature representation 321 is then used to generate a reconstructed face image 360 via a reconstruction model 350. The reconstruction model 350 may be implemented, for example, as a decoder-type neural network configured to invert the abstracted feature representation back into an image resembling the original input. The purpose of the reconstruction model 350 is to evaluate how much information about the original face image is preserved in the extracted first feature representation 321. During training, the reconstruction model 350 is trained using a reconstruction loss 361, which measures the dissimilarity between the reconstructed face image 360 and the training face image 301, such as by a pixel-wise mean squared error or other suitable loss metrics.

The reconstruction loss 361 is further used to derive an adversarial loss 362, which penalizes the ability of the first feature extraction model 311 to retain appearance-related features, thereby promoting the extraction of gaze-relevant information while suppressing irrelevant details. In an implementation, the adversarial loss 362 may be calculated as one minus the reconstruction loss 361, such that a larger reconstruction loss results in a smaller adversarial loss and vice versa, but the present disclosure is not limited thereto. Other adversarial loss designs may be used, provided that they enforce an adversarial relationship wherein the reconstruction loss 361 is inversely related to the adversarial loss 362.

Meanwhile, the first feature representation 321 is also combined with a second feature representation 322 (not illustrated in detail in FIG. 3 for conciseness) to form a combined feature representation 325, which is input to a regression model 330 to predict a gaze direction 340. The predicted gaze direction 340 is compared against a ground-truth gaze label 341 to compute a gaze estimation loss 342. Both the adversarial loss 362 and the gaze estimation loss 342 are back-propagated to update the parameters of the first feature extraction model 311.

In an alternative embodiment, the adversarial training of the first feature extraction model 311 may be implemented using a gradient reversal mechanism. Specifically, instead of explicitly defining the adversarial loss 362 as a function of the reconstruction loss 361, a gradient reversal layer (GRL) may be inserted between the first feature representation 321 and the reconstruction model 350. During the forward pass, the gradient reversal layer allows the first feature representation 321 to be fed into the reconstruction model 350 without modification. During the backward pass, however, the gradient reversal layer multiplies the gradients from the reconstruction loss 361 by a negative scalar, effectively reversing the direction of the gradients received by the first feature extraction model 311. As a result, the first feature extraction model 311 is trained adversarially to maximize the reconstruction loss 361, thereby suppressing the encoding of gaze-irrelevant features such as luminance features and individual appearance features. Although this alternative design achieves the adversarial effect without the need to explicitly define a separate adversarial loss, it may increase computational overhead, as the reconstruction model 350 must participate in both the forward and full backward propagation during each training iteration, and additional operations associated with gradient reversal are required.

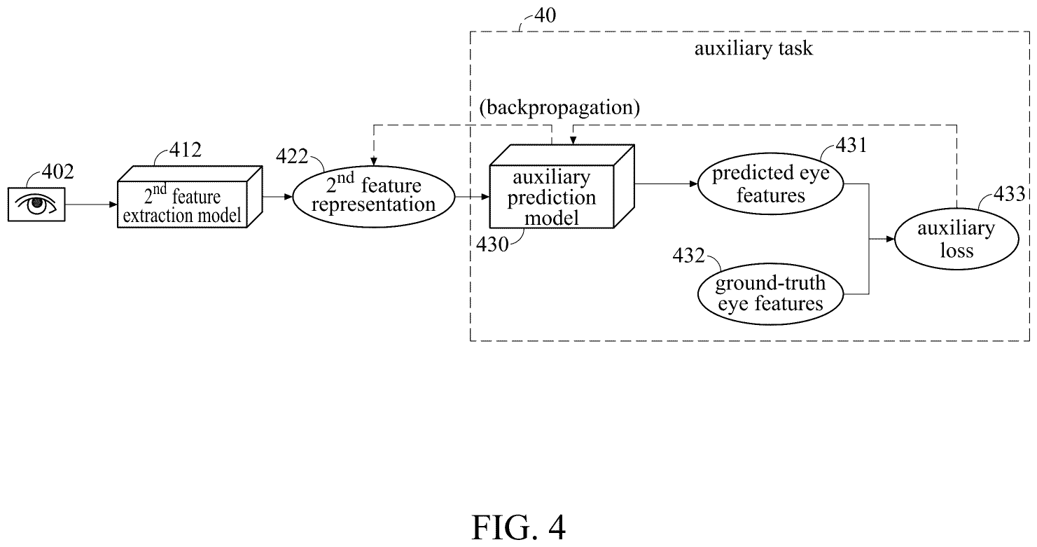

In an embodiment, the model training unit is further configured to train the second feature extraction model using an auxiliary task configured to predict one or more pre-defined eye features from the training eye image. The auxiliary task is designed to encourage the second feature extraction model to preserve information relevant to the pre-defined eye features in the second feature representation. The pre-defined eye features include but not limited to eyelids, eye corners, iris boundaries, limbus boundaries, pupil center, eyeball center, or any combination thereof. Further details regarding the training process of the second feature extraction model are illustrated in FIG. 4 and will be described below.

FIG. 4 illustrates a training process that uses an auxiliary task 40 for training the second feature extraction model 412, according to an embodiment of the present disclosure. As shown in FIG. 4, a training eye image 402 is provided as an input to the second feature extraction model 412, which generates a second feature representation 422. The second feature representation 422 is then fed into an auxiliary prediction model 430 within the auxiliary task 40. The auxiliary prediction model 430 is configured to predict one or more pre-defined eye features, represented as predicted eye features 431. In parallel, corresponding ground-truth eye features 432 serve as supervision material for training. A comparison between the predicted eye features 431 and the ground-truth eye features 432 is performed to compute an auxiliary loss 433, which reflects the prediction error.

The auxiliary loss 433 is propagated backward through the auxiliary prediction model 430 and the second feature extraction model 412 during the training process. In particular, gradients are backpropagated to adjust the parameters of the second feature extraction model 412 in a manner that encourages the second feature representation 422 to preserve information relevant to the pre-defined eye features, such as eyelids, eye corners, iris boundaries, limbus boundaries, pupil center, and/or eyeball center. The auxiliary prediction model 430 itself may be implemented using any suitable neural network architecture, such as a multi-layer perceptron (MLP) or a convolutional neural network (CNN), but the present disclosure is not limited thereto. In this manner, the auxiliary task 40 enhances the main gaze estimation task by improving the feature richness and task relevance of the second feature extraction model 412.

In some embodiments, the auxiliary loss 433 may be further combined with the main task loss, such as the gaze estimation loss, to form a joint optimization objective. A weighting factor may be assigned to the auxiliary loss 433 to balance its contribution relative to the gaze estimation loss during training. In such cases, the total training loss is minimized with respect to the parameters of both the second feature extraction model 412 and the auxiliary prediction model 430. The weighting factor may be constant or dynamically adjusted over training epochs, depending on specific implementation choices. By incorporating the auxiliary loss 433 into a joint optimization framework, the gaze estimation system can enhance the relevance of extracted features to eye landmarks while maintaining high accuracy in gaze direction estimation.

In an embodiment, the first feature extraction model may also be trained using a similar auxiliary task. Specifically, the auxiliary task is configured to predict one or more pre-defined facial features from the training face image. The auxiliary task is designed to encourage the first feature extraction model to preserve information relevant to the pre-defined facial features in the first feature representation. The pre-defined facial features include, but are not limited to, facial geometry information such as positions of the nose, mouth, and facial contours, and/or head pose information such as yaw, pitch, and/or roll angles of the subject's head. The predicted facial features may be compared against ground-truth labels to compute an auxiliary loss, which is then back-propagated to optimize the parameters of the first feature extraction model.

In some embodiments, the auxiliary task for predicting facial features may be used in combination with the adversarial mechanism described previously. That is, the first feature extraction model may be jointly optimized by minimizing the gaze estimation loss, the auxiliary loss associated with the facial feature prediction, and the adversarial loss designed to suppress gaze-irrelevant features. Through this multi-task training framework, the first feature extraction model can be guided to extract feature representations that are simultaneously informative for gaze estimation, predictive of facial structures, and robust against irrelevant variations such as illumination and individual appearance differences.

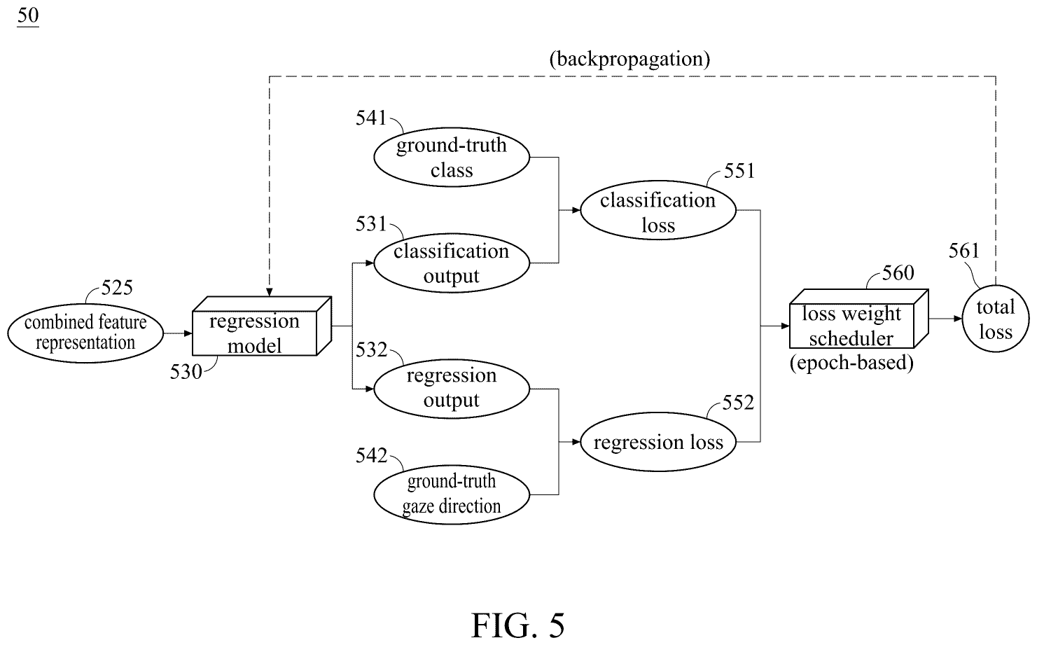

In an embodiment, the training process of the regression model involves applying a classification loss for coarse gaze direction estimation and a regression loss for fine-grained gaze direction estimation. Further details regarding this training process are illustrated in FIG. 5 and will be described below.

FIG. 5 illustrates a training process 50 for training the regression model 530, according to an embodiment of the present disclosure. As shown in FIG. 5, the combined feature representation 525 is input to the regression model 530. The regression model 530 is configured to simultaneously output a classification output 531 and a regression output 532. The classification output 531 represents a coarse gaze class, while the regression output 532 represents a fine-grained gaze direction prediction.

The classification output 531 is compared with a ground-truth class 541 to compute a classification loss 551, while the regression output 532 is compared with a ground-truth gaze direction 542 to compute a regression loss 552. The ground-truth class 541 may correspond to a discretized gaze region or gaze sector, obtained by dividing the gaze space into multiple discrete categories. In contrast, the ground-truth gaze direction 542 typically represents a continuous-valued vector or angular representation of the subject's gaze.

The classification loss 551 and the regression loss 552 are then combined using a loss weight scheduler 560 to produce a total loss 561. In particular, the loss weight scheduler 560 dynamically adjusts the relative weighting of the classification loss 551 and the regression loss 552 based on the training epoch. Initially, during earlier epochs of training, the classification loss 551 is assigned a higher weight to promote coarse gaze estimation performance. As training progresses, the weight of the classification loss 551 is gradually decreased, and the weight of the regression loss 552 is correspondingly increased, thereby shifting the training emphasis towards fine-grained gaze direction prediction. This strategy enables the regression model 530 to first learn a rough estimation of the gaze direction before refining its prediction to a more precise level.

The total loss 561, computed by the loss weight scheduler 560, is used for backpropagation to update the parameters of the regression model 530. Through this epoch-based adjustment mechanism, the training process 50 ensures a smoother optimization trajectory and improved overall gaze estimation accuracy.

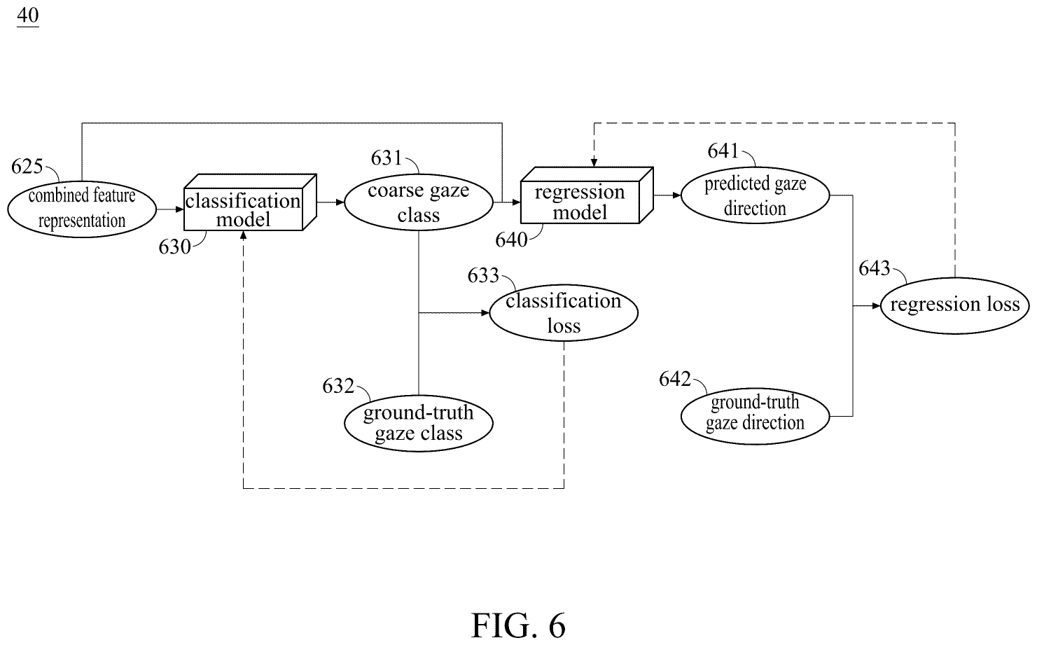

In an alternative embodiment, the gaze estimation system adopts a class-informed regression approach. In particular, during the inference phase, the gaze direction of the subject is determined by applying a classification model to the combined feature representation to generate a coarse gaze class, and applying the regression model to determine the gaze direction based on the combined feature representation and the coarse gaze class. During the training phase, the classification model is trained using a classification loss, while the regression model is trained using a regression loss. Further details regarding the training process of the classification model and the regression model are illustrated in FIG. 6 and will be described below.

FIG. 6 illustrates a training process 60 for training the classification model 630 and the regression model 640, according to an embodiment of the present disclosure. As shown in FIG. 6, the combined feature representation 625 is input to the classification model 630. The classification model 630 outputs a coarse gaze class 631, representing a discrete categorization of the subject's gaze direction. The coarse gaze class 631 is compared with a ground-truth gaze class 632 to compute a classification loss 633, which is used for backpropagation to update the classification model 630.

Meanwhile, the coarse gaze class 631 is also utilized by the regression model 640. The regression model 640 receives both the combined feature representation 625 and the coarse gaze class 631 as inputs, and generates a predicted gaze direction 641. The predicted gaze direction 641 is compared with a ground-truth gaze direction 642 to compute a regression loss 643, which is used for backpropagation to update the regression model 640.

In this class-informed regression approach, the classification model 630 acts as a pre-processing stage that provides coarse gaze information to the regression model 640, enabling the regression model 640 to focus on refining the gaze prediction within a narrower and more relevant range. This training strategy effectively reduces the learning difficulty of the regression task and improves overall prediction accuracy.

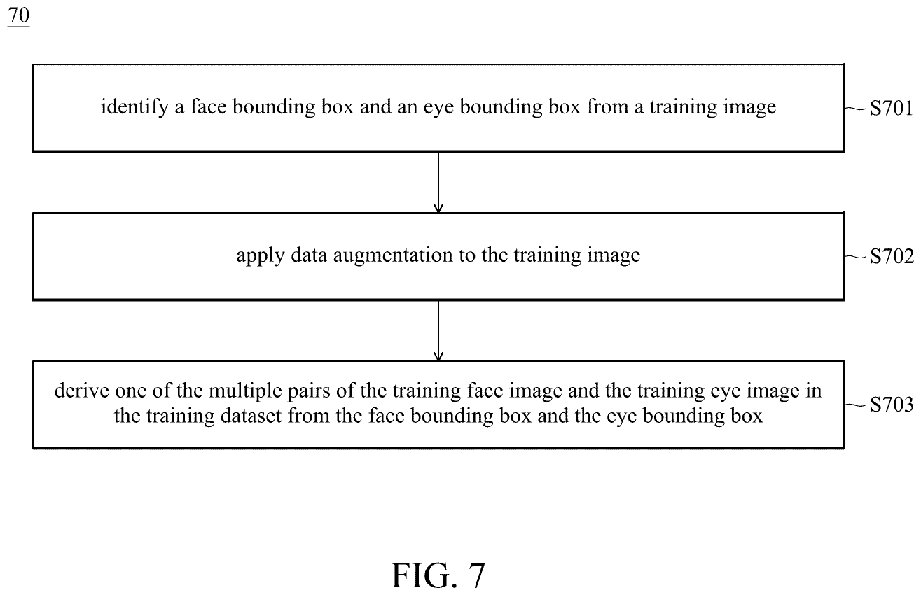

FIG. 7 illustrates a process 70 for constructing the training dataset, according to an embodiment of the present disclosure. As shown in FIG. 7, the process 70 includes steps S701-S703.

In step S701, the model training unit identifies a face bounding box and an eye bounding box from a training image. The face bounding box refers to a rectangular region encompassing the subject's facial area, while the eye bounding box refers to a rectangular region encompassing an eye region of the subject. These bounding boxes can be generated using object detection models trained to detect faces and eyes, or alternatively through landmark-based methods that infer bounding regions from detected keypoints. Each bounding box is typically represented by coordinates specifying its center point, width, and height, or alternatively by coordinates of two diagonally opposite corners, but the present disclosure is not limited thereto.

In step S702, the model training unit applies data augmentation to the training image. The data augmentation may include, but is not limited to:
(i) Applying a scaling transformation to the face bounding box and the eye bounding box: The scaling operation enlarges or shrinks the size of the bounding boxes by a random factor within a predefined range (for example, between 0.8 and 1.2), which helps the model generalize better to variations in face and eye sizes at different distances from the camera;
(ii) Applying a translation transformation to the face bounding box and the eye bounding box: The translation operation randomly shifts the bounding boxes along the x-axis and/or y-axis within a limited range (e.g., ±20% of the bounding box size), thereby simulating misalignment or imperfect detections that could occur in real-world scenarios; and/or
(iii) Adjusting a luminance level of the training image: This operation varies the brightness of the training image to simulate different lighting conditions, thereby making the trained models more robust to illumination changes such as overexposure and underexposure, or low-light scenes such as nighttime, backlight, shadows, and local uneven lighting.
   These augmentation techniques enhance the diversity of the training samples and improve the model's generalization ability and robustness to real-world variability.

In step S703, the model training unit derives one of the multiple pairs of the training face image and the training eye image in the training dataset from the face bounding box and the eye bounding box. Specifically, the model training unit crops the training face image and the training eye image from the training image according to the augmented face bounding box and eye bounding box, respectively. The cropped images are then resized to standardized resolutions as needed for model input. Each pair of the training face image and the training eye image, along with the corresponding gaze label, forms an entry in the training dataset, which is subsequently used to train the first feature extraction model, the second feature extraction model, and the regression model.

Although the steps S701 to S703 are illustrated in a specific order, it should be understood that the present disclosure is not limited thereto. In some implementations, the order of the steps may be altered. For instance, step S702 and step S703 may be performed in a different sequence, such as deriving a pair of a training face image and a training eye image first and then applying data augmentation thereto.

In an embodiment, the data augmentation performed in step S702 may further include generating a mask based on eye landmarks, and applying the mask to the training image to selectively preserve a gaze-relevant region in the training eye image. Specifically, a set of eye landmarks corresponding to physical structures such as eyelid contours, eye corners, iris boundaries, and/or pupil centers may be detected or estimated from the training image. Based on the detected eye landmarks, a mask is created to delineate the region of the eye that is most relevant to gaze estimation. The mask may take the form of a binary or soft-weighted mask, emphasizing the central gaze-relevant area (e.g., the iris and pupil) while attenuating or excluding surrounding regions (e.g., eye sockets, skin areas). The mask is then applied to the training eye image by, for instance, pixel-wise multiplication or weighted blending, so as to enhance the visibility and prominence of the gaze-relevant features while reducing the influence of gaze-irrelevant features such as occlusions, reflections, or noise around the eye. This augmentation technique helps improve the robustness and generalization ability of the second feature extraction model by guiding it to focus on informative regions that are critical for accurate gaze direction inference.

In an embodiment, the camera device 11 illustrated in FIG. 1 is a near-infrared (NIR) camera configured to capture the image of the subject as a grayscale image. Utilizing a NIR camera allows the system to operate reliably under varying lighting conditions and enhances the contrast of certain facial features, such as the pupil and iris, which are critical for gaze estimation. Because NIR imaging inherently provides grayscale outputs instead of full-color images, the system benefits from reduced computational requirements for subsequent image processing and feature extraction stages.

Correspondingly, the first feature extraction model, the second feature extraction model, and the regression model are trained using grayscale training images converted from color images via a model trained to simulate near-infrared image characteristics. Specifically, a machine learning model (e.g., a convolutional neural network) may be pre-trained to map RGB images captured under visible light to synthetic NIR-like grayscale images. This conversion process helps align the characteristics of the training dataset with those of the real-world input captured by the NIR camera device during inference. By training the models on grayscale images exhibiting NIR-like properties, the gaze estimation system can achieve higher robustness and consistency across diverse environmental conditions, such as low-light or high-glare scenarios, where conventional RGB imaging might struggle. Furthermore, the use of grayscale inputs reduces the number of input channels, leading to lower memory consumption and faster inference times, which is particularly beneficial for deployment on resource-constrained platforms.

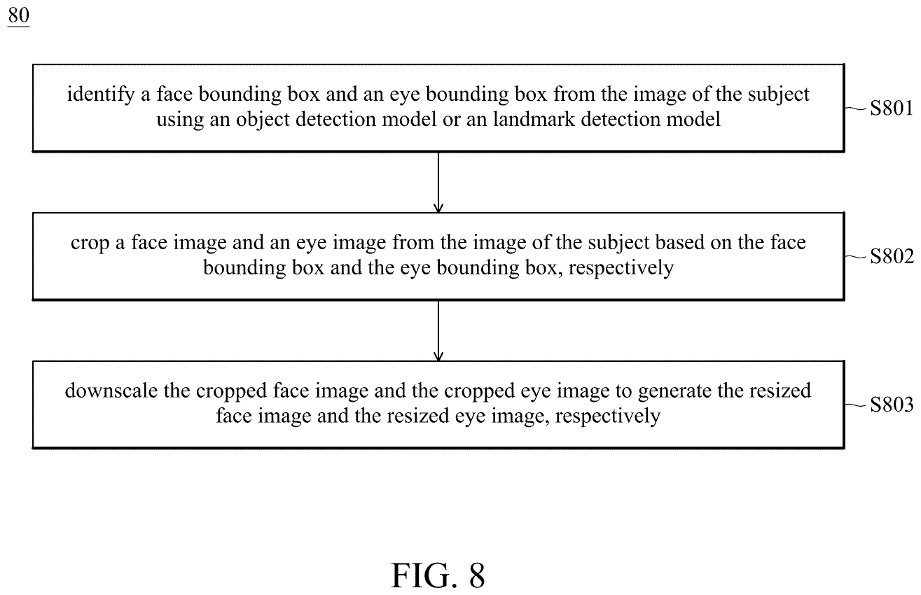

FIG. 8 illustrates a pre-processing process 80 executed by the image processing unit 13 of FIG. 1, prior to the feature extraction operations, according to an embodiment of the present disclosure. The pre-processing process 80 prepares the image data of the subject in a format suitable for subsequent gaze estimation analysis. As shown in FIG. 8, the pre-processing process 80 includes steps S801-S803.

In step S801, the image processing unit 13 identifies a face bounding box and an eye bounding box from the image of the subject using an object detection model or a landmark detection model. The object detection model may be a machine learning-based model, such as a convolutional neural network (CNN) and its variants such as R-CNN, Fast R-CNN, Mask R-CNN, and YOLO, trained to locate face and eye regions in images. Alternatively, a landmark detection model may be used to detect specific facial landmarks (e.g., eye corners, nose tip), from which bounding boxes for the face and eyes can be derived. Detailed explanations regarding the definitions, acquisition approaches, and representations of the face bounding box and the eye bounding box have been provided in earlier descriptions, and thus are omitted here for brevity.

In step S802, the image processing unit 13 crops a face image and an eye image from the image of the subject based on the face bounding box and the eye bounding box, respectively. In particular, the face bounding box defines a region of interest encompassing the subject's facial features, while the eye bounding box isolates the region specifically corresponding to the subject's eye. The cropping operation extracts pixel regions within these bounding boxes to generate the face image and the eye image. This operation effectively reduces irrelevant background information and enhances the focus on meaningful areas for subsequent feature extraction.

In step S803, the image processing unit 13 downscales the cropped face image and the cropped eye image to generate the resized face image and the resized eye image, respectively. Downscaling serves to normalize the input sizes for the feature extraction models and to reduce computational overhead during inference. The downscaling operation may use interpolation techniques such as bilinear interpolation, bicubic interpolation, or other suitable image resizing approaches, but the present disclosure is not limited thereto.

In an embodiment, in step S803, the cropped face image and the cropped eye image are downscaled, such that the resized eye image preserves more pixel-level detail corresponding to an eye of the subject than a corresponding eye region within the resized face image. Specifically, the face image, which originally includes the entire facial region, is resized to a standard resolution (e.g., 120×120 pixels), whereas the eye image, initially focused on a smaller eye region, is resized to a different resolution (e.g., 60×36 pixels) optimized for capturing fine-grained ocular features. As a result, the resized eye image retains a higher pixel density and finer granularity for the eye region compared to the eye portion within the resized face image, thereby facilitating more precise extraction of gaze-relevant features.

In practical terms, this design ensures that critical gaze-relevant structures, such as the iris, eyelid contours, and pupil center, retain higher fidelity in the resized eye image than if inferred solely from the resized face image. Consequently, this arrangement enhances the overall gaze estimation accuracy by enabling the feature extraction models to leverage both broad contextual information from the face and fine local details from the eye.

It should be noted that while specific resizing resolutions may vary depending on implementation needs, the principle of allocating greater pixel density to the isolated eye region remains consistent across different implementations.

In an embodiment, the image processing unit 13 is further configured to detect whether there are multiple face regions in the image 100 of the subject. In response to detecting multiple face regions in the image 100 of the subject, the image processing unit 13 selects the face bounding box based on proximity to a predefined reference position within the image. Specifically, the predefined reference position may correspond to an expected location of the primary subject, such as a driver's seat region in an in-vehicle camera setup. For instance, in a vehicle application scenario, it is common that the image captured by the camera device 11 may simultaneously include the faces of the driver and one or more passengers. In such cases, merely detecting multiple face regions without additional filtering may result in selecting the wrong subject, leading to erroneous gaze estimation results.

By using the relatively fixed spatial relationship between the camera device and the driver's seating position, where the driver's face is expected to consistently appear near a predetermined location within the captured image, the image processing unit 13 can effectively distinguish the driver from passengers. This approach helps prevent confusion arising from incidental face appearances (e.g., as a rear-seat passenger leaning forward), thereby improving the reliability of subsequent gaze estimation.

In an embodiment, the image processing unit 13 is further configured to identify a left eye bounding box and a right eye bounding box from the image 100 of the subject. Subsequently, the image processing unit 13 selects, from the left eye bounding box and the right eye bounding box, the one that is closer to the camera device 11 as the eye bounding box for cropping the eye image. The proximity of each eye bounding box to the camera device 11 may be estimated based on bounding box size, focus sharpness, or other visual cues extracted from the image, but the present disclosure is not limited thereto.

Such selection can enhance the quality and reliability of the extracted eye image for subsequent feature extraction. Typically, the eye that is spatially closer to the camera device 11 appears larger and clearer in the captured image, offering richer pixel-level details essential for accurate gaze estimation. By selecting the closer eye, the system can maximize the resolution and minimize distortions caused by oblique viewing angles or perspective effects.

In a further embodiment, the image processing unit 13 is further configured to incorporate a hysteresis mechanism to avoid frequent switching between the left and right eye bounding boxes across consecutive frames, thereby mitigating jitter effects in the gaze estimation results. Specifically, the image processing unit 13 is configured to maintain the selected eye bounding box across multiple frames and to switch to the other eye bounding box for cropping the eye image only when a predefined condition indicating a sufficient change is satisfied.

The predefined condition may involve criteria such as a substantial decrease in the relative size or clarity of the currently selected eye bounding box, or a significant improvement in the alternative eye bounding box in terms of proximity or visual quality. For instance, the system may define threshold values for bounding box size ratios, focus metrics, or detection confidence scores. Only when these thresholds are exceeded does the system permit a switch from the currently tracked eye to the alternative eye.

By using such a hysteresis mechanism, the gaze estimation system prevents unnecessary switching triggered by minor or transient variations, such as small head movements or detection noise. This contributes to a smoother and more stable gaze tracking experience, particularly important in dynamic environments such as in-vehicle driver monitoring.

In an embodiment, the processing circuitry 12 is further configured to perform at least one of the following actions based on the determined gaze direction 140:
(i) Modifying a display output of a display device: In a vehicular application, if the gaze direction indicates that the driver is not attending to a critical area, such as an intersection or a merging lane, the display unit within the vehicle may automatically enlarge, highlight, or reposition navigation cues or hazard warnings to attract the driver's attention. For another instance, in a digital signage or advertisement display system deployed in public areas, the content displayed on a screen may be dynamically adjusted based on the region of the display that has attracted the gaze of passing pedestrians, thereby optimizing the advertisement's effectiveness.
(ii) Flashing an indicator light: In safety-critical environments such as driving, if the gaze estimation system detects that the driver's attention has deviated from the road for a threshold period, an indicator light on the dashboard may begin to flash to prompt the driver to re-focus attention on driving.
(iii) Generating an audio alert through an audio output device: An audio warning tone or a voice prompt may be generated via the car's speaker system if the driver is detected to be distracted or drowsy based on gaze patterns, thereby providing an immediate sensory cue that is hard to ignore even if visual focus is lost.
(iv) Activating an autopilot unit to take over vehicle control: In advanced driver-assistance systems (ADAS) or autonomous vehicles, if the gaze direction indicates prolonged inattention, or if a dangerous situation is detected while the driver is distracted, the system may activate an autopilot control unit to temporarily take over vehicle control, such as maintaining lane keeping, braking, or performing emergency maneuvers to prevent accidents.
(v) Activating a haptic output device to generate a vibration alert: A haptic actuator embedded in the steering wheel or driver's seat may be triggered to produce a vibration alert if the driver's gaze direction suggests a loss of attention. The tactile feedback can serve as an immediate and intuitive warning without requiring visual or auditory processing, thereby improving reaction time in critical situations.
   However, the present disclosure is not limited to the aforementioned examples, and other responsive actions based on gaze direction may also be implemented.

According to the embodiments of the present disclosure, the gaze estimation system and method described herein effectively address various limitations encountered in prior techniques. In particular, by separately extracting features from both a face image and an eye image and combining them for gaze estimation, the system is able to simultaneously capture broader facial context and fine-grained ocular details, resulting in improved gaze estimation accuracy. Furthermore, the introduction of an adversarial training mechanism for the face feature extraction model suppresses gaze-irrelevant features, such as variations in luminance and individual appearance, which previously degraded estimation robustness.

Additionally, by using auxiliary tasks to encourage the preservation of gaze-relevant facial and eye features during feature extraction, the system enhances the semantic richness of intermediate feature representations, thereby facilitating more precise inference. The use of dynamic loss weighting strategies during regression model training further mitigates bias and variance issues that typically arise in gaze estimation tasks.

Through careful pre-processing of input images, including intelligent selection of face and eye bounding boxes and targeted resizing strategies, the system ensures that essential visual information is preserved even under hardware and computational constraints. Moreover, by integrating mechanisms such as hysteresis control for eye selection, and by enabling responsive actions based on the estimated gaze direction, the system achieves practical reliability and responsiveness suitable for real-world applications, such as driver monitoring, digital signage interaction, and customer behavior analysis.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A gaze estimation system, comprising:
a camera device, configured to capture an image of a subject; and
a processing circuitry, coupled to the camera device, the processing circuitry comprising:
an image processing unit, configured to derive a resized face image and a resized eye image from the image of the subject; and
a gaze inference unit, configured to:
extract a first feature representation from the resized face image using a first feature extraction model,
extract a second feature representation from the resized eye image using a second feature extraction model,
combine the first feature representation and the second feature representation to generate a combined feature representation, and
determine a gaze direction of the subject based on the combined feature representation using a regression model.

2. The gaze estimation system as claimed in claim 1, further comprising:
a model training unit, configured to train the first feature extraction model, the second feature extraction model, and the regression model jointly using a training dataset comprising multiple pairs of a training face image and a training eye image, and corresponding gaze labels.

3. The gaze estimation system as claimed in claim 2, wherein the model training unit is further configured to optimize the first feature extraction model using a training loss comprising a gaze estimation loss and an adversarial loss, wherein the gaze estimation loss is minimized to preserve gaze-relevant features, and the adversarial loss is minimized to suppress gaze-irrelevant features, wherein the gaze-irrelevant features include luminance features and individual appearance features.

4. The gaze estimation system as claimed in claim 3, wherein the model training unit is further configured to generate a reconstructed face image from the first feature representation using a reconstruction model, and compute the adversarial loss based on a reconstruction loss between the reconstructed face image and the training face image.

5. The gaze estimation system as claimed in claim 2, wherein the model training unit is further configured to identify a face bounding box and an eye bounding box from a training image, apply data augmentation to the training image, and derive one of the multiple pairs of the training face image and the training eye image in the training dataset from the face bounding box and the eye bounding box,
wherein the data augmentation comprises at least one of:
applying a scaling transformation to the face bounding box and the eye bounding box,
applying a translation transformation to the face bounding box and the eye bounding box, or
adjusting a luminance level of the training image.

6. The gaze estimation system as claimed in claim 5, wherein the data augmentation further comprises generating a mask based on eye landmarks, and applying the mask to the training image to selectively preserve a gaze-relevant region in the training eye image.

7. The gaze estimation system as claimed in claim 2, wherein the model training unit is further configured to train the second feature extraction model using an auxiliary task configured to predict one or more pre-defined eye features from the training eye image,
wherein the auxiliary task is designed to encourage the second feature extraction model to preserve information relevant to the pre-defined eye features in the second feature representation, the pre-defined eye features comprising at least one of:
eyelids,
eye corners,
iris boundaries,
limbus boundaries,
a pupil center, or
an eyeball center.

8. The gaze estimation system as claimed in claim 2, wherein the model training unit is further configured to train the first feature extraction model using an auxiliary task configured to predict one or more pre-defined facial features from the training face image,
wherein the auxiliary task is designed to encourage the first feature extraction model to preserve information relevant to the pre-defined facial features in the first feature representation, the pre-defined facial features comprising at least one of:
facial geometry information, or
head pose information.

9. The gaze estimation system as claimed in claim 2, wherein the model training unit is further configured to train the regression model using a training process that comprises applying a classification loss for coarse gaze direction estimation and a regression loss for fine-grained gaze direction estimation,
wherein a weight of the classification loss decreases and another weight of the regression loss increases with training epoch.

10. The gaze estimation system as claimed in claim 2, wherein the gaze inference unit is further configured to determine the gaze direction of the subject by applying a classification model to the combined feature representation to generate a coarse gaze class, and applying a regression model to determine the gaze direction based on the combined feature representation and the coarse gaze class, and
wherein the model training unit is further configured to train the classification model using a classification loss and the regression model using a regression loss.

11. The gaze estimation system as claimed in claim 1, wherein the image processing unit is further configured to derive the resized face image and the resized eye image by executing steps comprising:
identifying a face bounding box and an eye bounding box from the image of the subject using an object detection model or a landmark detection model;
cropping a face image and an eye image from the image of the subject based on the face bounding box and the eye bounding box, respectively; and
downscaling the cropped face image and the cropped eye image to generate the resized face image and the resized eye image, respectively.

12. The gaze estimation system as claimed in claim 11, wherein the image processing unit is further configured to downscale the cropped face image and the cropped eye image, such that the resized eye image preserves more pixel-level detail corresponding to an eye of the subject than a corresponding eye region within the resized face image.

13. The gaze estimation system as claimed in claim 11, wherein in response to detecting multiple face regions in the image of the subject, the image processing unit is further configured to select the face bounding box based on proximity to a predefined reference position within the image.

14. The gaze estimation system as claimed in claim 11, wherein the image processing unit is further configured to identify a left eye bounding box and a right eye bounding box from the image of the subject and to select, from the left eye bounding box and the right eye bounding box, the one that is closer to the camera device as the eye bounding box for cropping the eye image.

15. The gaze estimation system as claimed in claim 14, wherein the image processing unit is further configured to maintain the selected eye bounding box across multiple frames and to switch to the other eye bounding box for cropping the eye image only when a predefined condition indicating a sufficient change is satisfied.

16. The gaze estimation system as claimed in claim 1, wherein the camera device is a near-infrared camera configured to capture the image of the subject as a grayscale image, and the first feature extraction model, the second feature extraction model, and the regression model are trained using grayscale training images converted from color images via a model trained to simulate near-infrared image characteristics.

17. The gaze estimation system as claimed in claim 1, wherein the processing circuitry is further configured to perform at least one action based on the determined gaze direction, the at least one action comprising at least one of:
modifying a display output of a display device,
flashing an indicator light,
generating an audio alert through an audio output device,
activating an autopilot unit to take over vehicle control, or
activating a haptic output device to generate a vibration alert.

18. A gaze estimation method, executed by one or more processors, the method comprising:
deriving a resized face image and a resized eye image from an image of a subject captured by a camera device;
extracting a first feature representation from the resized face image using a first feature extraction model, and extracting a second feature representation from the resized eye image using a second feature extraction model,
combining the first feature representation and the second feature representation to generate a combined feature representation; and
determining a gaze direction of the subject based on the combined feature representation using a regression model.

19. The gaze estimation method as claimed in claim 18, further comprising:
training the first feature extraction model, the second feature extraction model, and the regression model jointly using a training dataset comprising multiple pairs of a training face image and a training eye image, and corresponding gaze labels.

20. The gaze estimation method as claimed in claim 19, further comprising:
optimizing the first feature extraction model using a training loss comprising a gaze estimation loss and an adversarial loss,
wherein the gaze estimation loss is minimized to preserve gaze-relevant features, and the adversarial loss is minimized to suppress gaze-irrelevant features, wherein the gaze-irrelevant features include luminance features and individual appearance features.

21. The gaze estimation method as claimed in claim 20, further comprising:
generating a reconstructed face image from the first feature representation using a reconstruction model, and
computing the adversarial loss based on a reconstruction loss between the reconstructed face image and the training face image.

22. The gaze estimation method as claimed in claim 19, further comprising:
identifying a face bounding box and an eye bounding box from a training image,
applying data augmentation to the training image, and
deriving one of the multiple pairs of the training face image and the training eye image in the training dataset from the face bounding box and the eye bounding box,
wherein the data augmentation comprises at least one of:
applying a scaling transformation to the face bounding box and the eye bounding box,
applying a translation transformation to the face bounding box and the eye bounding box, or
adjusting a luminance level of the training image.

23. The gaze estimation method as claimed in claim 22, wherein the data augmentation further comprises generating a mask based on eye landmarks, and applying the mask to the training image to selectively preserve a gaze-relevant region in the training eye image.

24. The gaze estimation method as claimed in claim 19, further comprising:
training the second feature extraction model using an auxiliary task configured to predict one or more pre-defined eye features from the training eye image,
wherein the auxiliary task is designed to encourage the second feature extraction model to preserve information relevant to the pre-defined eye features in the second feature representation, the pre-defined eye features comprising at least one of:
eyelids,
eye corners,
iris boundaries,
limbus boundaries,
a pupil center, or
an eyeball center.

25. The gaze estimation method as claimed in claim 19, further comprising:
training the first feature extraction model using an auxiliary task configured to predict one or more pre-defined facial features from the training face image,
wherein the auxiliary task is designed to encourage the first feature extraction model to preserve information relevant to the pre-defined facial features in the first feature representation, the pre-defined facial features comprising at least one of:
facial geometry information, or
head pose information.

26. The gaze estimation method as claimed in claim 19, further comprising:
training the regression model using a training process that comprises applying a classification loss for coarse gaze direction estimation and a regression loss for fine-grained gaze direction estimation,
wherein a weight of the classification loss decreases and another weight of the regression loss increases with training epoch.

27. The gaze estimation method as claimed in claim 19, further comprising:
determining the gaze direction of the subject by applying a classification model to the combined feature representation to generate a coarse gaze class, and applying a regression model to determine the gaze direction based on the combined feature representation and the coarse gaze class,
wherein the classification model is trained using a classification loss, and the regression model using a regression loss.

28. The gaze estimation method as claimed in claim 18, wherein deriving the resized face image and the resized eye image further comprises:
identifying a face bounding box and an eye bounding box from the image of the subject using an object detection model or a landmark detection model;
cropping a face image and an eye image from the image of the subject based on the face bounding box and the eye bounding box, respectively; and
downscaling the cropped face image and the cropped eye image to generate the resized face image and the resized eye image, respectively.

29. The gaze estimation method as claimed in claim 28, wherein the cropped face image and the cropped eye image are downscaled, such that the resized eye image preserves more pixel-level detail corresponding to an eye of the subject than a corresponding eye region within the resized face image.

30. The gaze estimation method as claimed in claim 28, further comprising:
in response to detecting multiple face regions in the image of the subject, selecting the face bounding box based on proximity to a predefined reference position within the image.

31. The gaze estimation method as claimed in claim 28, further comprising:
identifying a left eye bounding box and a right eye bounding box from the image of the subject, and
selecting, from the left eye bounding box and the right eye bounding box, the one that is closer to the camera device as the eye bounding box for cropping the eye image.

32. The gaze estimation method as claimed in claim 31, further comprising:
maintaining the selected eye bounding box across multiple frames, and switching to the other eye bounding box for cropping the eye image only when a predefined condition indicating a sufficient change is satisfied.

33. The gaze estimation method as claimed in claim 18, wherein the camera device is a near-infrared camera configured to capture the image of the subject as a grayscale image, and wherein the first feature extraction model, the second feature extraction model, and the regression model are trained using grayscale training images converted from color images via a model trained to simulate near-infrared image characteristics.

34. The gaze estimation method as claimed in claim 18, further comprising:
performing at least one action based on the determined gaze direction, the at least one action comprising at least one of:
modifying a display output of a display device,
flashing an indicator light,
generating an audio alert through an audio output device,
activating an autopilot unit to take over vehicle control, or
activating a haptic output device to generate a vibration alert.
